(19) United States
(12) Patent Application Publication
(10) Pub. No.: US 2007/0185966 A1
(43) Pub. Date: Aug. 9, 2007

(54) Device and method for controlling network equipment management data, for a communications network management system

(75) Inventors: Michel Chevanne, Clamart (FR); Philippe Drugmand, Fontenay Aux Roses (FR); Patrick Bergeot, Antony (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/697,125

(22) Filed: Oct. 31, 2003

(30) Foreign Application Priority Data
Nov. 4, 2002 (FR) 02 13 737

(51) Int. Cl. G06F 15/16

(52) U.S. Cl. 709/208

(57) ABSTRACT

A device (1) is dedicated to the control of management data for equipment (5) in a communications network comprising a network management system for managing the equipment (5) in the network using loaded management data modules, associated with the said equipment and stored in a memory (9). This device (1) comprises control means (10) capable, when the system makes a request to take over at least one new item of equipment (5), to extract from the memory (9) the management data module which is associated with each new item of equipment, and then loading into the system each new management data module extracted, dynamically, so that the management by the system of the other equipment in the network is not interrupted.

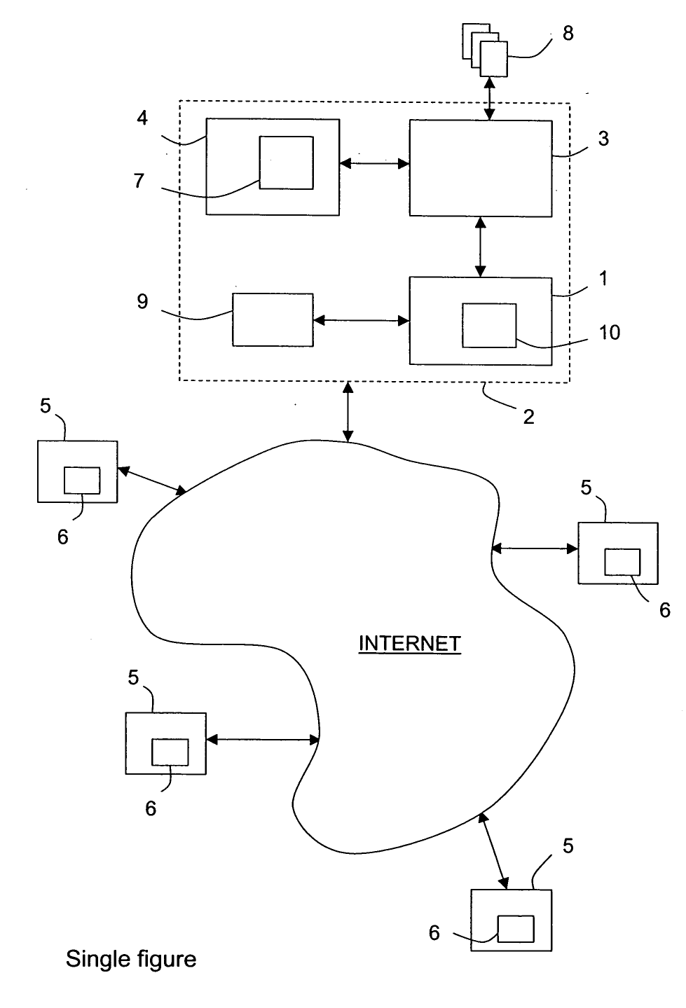

The invention concerns the field of the management of equipment in a communications network, and more particularly that of the control of the integration of new network equipment or new versions of network equipment by a network management system.

The majority of communications networks are equipped with tools coupled to a network management system, also referred to as the network operating system, enabling their manager (or supervisor) to manage the equipment which make them up. Such tools generally use functions and services, also referred to as OAM&P (standing for “Operations, Administration, Maintenance and Provisioning”).

Such a network management system is for example known from the patent application EP 0946020, in the name of the company NTT.

Here “network equipment” means any type of equipment, such as for example servers, terminals, switches, routers or concentrators, capable of exchanging data with the NMS management system according to a network management protocol, such as for example the SNMP protocol (standing for “Simple Network Management Protocol” RFC 2571-2580).

When a new item of equipment (or a new type of equipment) is put on the market, it must have a management data module, also referred to as a management application, in order to be able to be integrated in a network and managed by its manager. The integration then consists of loading, into a server of the NMS, the “new” management data module associated with this new equipment. Here “new equipment” means both modified existing equipment (for example modified by the replacement or addition of a card) and equipment of a new type.

However, to effect such a loading, it is necessary first to remove the “old” management data module used by the NMS for managing the old equipment and then to restart the configuration application for the whole of the network. This loading mode has at least two drawbacks. First of all, throughout these operations, the network equipment can no longer be managed by the NMS. Next, the loading of a new management data module does not guarantee its compatibility with the other management data modules associated with the other equipment managed by the NMS. Consequently, in the event of incompatibility, it may happen that the new equipment cannot synchronise itself with the NMS, which prevents management. The supervisor (or manager) of the network must then interrupt the management of the network in order to prevent unwanted alarms reaching the NMS.

The aim of the invention is therefore to remedy all or some of the aforementioned drawbacks.

It proposes for this purpose a device for controlling equipment management data in a communications network equipped with a network management system (NMS) capable of managing the network equipment using previously loaded management data modules, associated with the network equipment and stored in a memory.

This device is characterised by the fact that it comprises control means capable, when the NMS makes a request to take over at least one new item of equipment, to extract from the memory the management data module which is associated with each new item of equipment, and then to load into the NMS each new management data module extracted, dynamically, so that the management by the NMS of the other items of equipment in the network is not interrupted.

According to another characteristic of the invention, the control means can be arranged, whenever a new management data module is loaded, associated with a new version of an item of equipment which has not yet been integrated in the network whilst an “old” management data module associated with a prior version of this equipment is still loaded and the prior version is still integrated in the network, first of all to put the new management data module which has just been loaded on standby so as to continue the management of the old version of the equipment from the old associated loaded module, until the new version of the equipment is integrated. Next, when the control means receive data indicating the integration of the new version, they can put the new management data module previously loaded into service so as to provide the management of the new version of the equipment from this.

In this case, it is preferable for the putting on standby to consist firstly of allowing the management of the new version of the equipment from the associated new management data module, without taking account of any error messages related to its non-integration with the network, and secondly to send to the old management data module a message indicating to it that a change of version is under way and that it must not take account of at least some of the error messages related to the conjoint management of the old and new versions.

Moreover, and still in the case presented above, it may be advantageous for the control means to be capable of deleting (or unloading) the old management data module once they have been advised of the synchronisation between the new version of equipment and the new management data module.

In addition, the control means are preferentially arranged so as to load management data modules according to at least a first mode in which the modules are loaded independently of any dependences between them and a second mode in which, in loading the modules, account is taken of any dependences between them.

Preferentially, each management data module consists of at least one descriptor. By definition, a descriptor is a data processing module which contains all the data necessary for the management by the NMS of at least one equipment element (such as for example an integrated circuit card or a connection interface).

Preferentially, a descriptor is dedicated to an item of equipment and constitutes on the one hand program code files, preferably in Java language (because of its ability to load and unload codes dynamically), including a first set of files for implementing an equipment interface, a second file containing first data designating the type of equipment and a third file containing second data designating the MIB definition associated with this equipment, and secondly at least one configuration file, for example of the XML type and containing information for managing a type of equipment in the network.

The invention also relates to a communications network management server equipped with a control device of the type presented above and management means capable of managing network equipment using previously loaded management modules, associated with the network equipment and stored in a memory.

The invention also relates to a method of controlling data for managing equipment in a communications network, in which the network equipment is managed using management data modules loaded, associated with these items of network equipment.

This method is characterised by the fact that it consists, in the event of a request to take over at least one new item of equipment in the network, dynamically loading each new management data module associated with a new item of equipment, so that the management of the other items of equipment in the network is not interrupted.

The method according to the invention can comprise supplementary characteristics which may be taken separately and/or in combination, and in particular:
in the event of the loading of a new management data module associated with a new version of equipment which has not yet been integrated in the network whilst an “old” management data module, associated with a prior version of equipment, is still loaded and this prior version is still integrated in the network, it is advantageous to commence by putting the new management data module which has just been loaded on standby so as to continue the management of the old version of the equipment using the associated old module loaded, until the new version of the equipment is integrated, and then to put the new loaded module in service when data are received indicating the integration of the new version, so that the management of the new version of the equipment is assured using this new management data module;
the putting on standby may consist firstly of allowing the management of the new version of equipment from the associated new management data module without taking account of any error messages related to its non-integration into the network and secondly sending to the old management data module a message indicating to it that a change of version is under way and that it must not take account of at least some of the error messages related to the conjoint management of the old and new versions;
in the event of synchronisation between the new version of equipment and the new management data module, the old management data module can be deleted;
the management data modules can be loaded independently of any dependencies thereof or take account of any dependencies thereof;
the management data modules can each consist of at least one descriptor of the type presented above.

The invention can in particular be implemented in all network technologies which must be managed, and in particular in transmission networks (for example of the WDM, SONET or SDH type), data networks (for example of the Internet-IP or ATM type) or voice networks (for example of the conventional, mobile or NGN type).

Other characteristics and advantages of the invention will emerge from an examination of the following detailed description and the accompanying single FIGURE which schematically illustrates an example of a communications network equipped with a control device according to the invention located in a network management server. This FIGURE can not only serve to supplement the invention but also contribute to its definition, where necessary.

The invention proposes a control device intended to enable the manager (or supervisor) of a communications network, via his network management system (or NMS), to rapidly access the management data for the network equipment which he wishes to manage and/or configure.

In the single FIGURE there is illustrated, by way of example, a communications network equipped with a control device 1 according to the invention. More precisely, in this example, the device 1 is located in a management server 2 of the management system of the NMS network, which also comprises a management module 3, coupled to the device 1 and to a graphical interface 4 of the GUI (standing for “Graphical User Interface”) type.

Naturally, the control device 1 can be located in a dedicated external box, coupled to the management server 2, or in the management module 3 of the said management server 2. Moreover, in the example illustrated, only one management server 2 has been shown but it may be envisaged that the NMS may comprise several management servers, each equipped with a management device 1, and for example intended each to allow the management of some of the items of equipment in the network.

As illustrated, the communications network comprises a multiplicity of network equipment 5 (here four in number, by way of example), such as peripheral or core servers, terminals, switches or routers, capable of exchanging data, according to a chosen network management protocol, with the NMS and in particular with its management server 2.

For example, the communications network is of the Internet (IP) type and the network management protocol is the SNMP (standing for “Simple Network Management Protocol” RFC 2571-2580). However, naturally, the invention applies to other types of network, such as for example to transmission networks of the WDM, SONET or SDH type, data networks of the ATM type or voice networks of the conventional, mobile or NGN type, and to other network management protocols such as for example TL1, CORBA or CMISE/CMIP.

In addition, each item of equipment 5 conventionally comprises a management information base 6 (or MIB), also called an object instance base. Each MIB 6 comprises information fields whose specific values characterise the associated equipment and can be accessed by a browser 7, generally located in the graphical interface 4. In addition, each MIB 6 is associated with a management information base definition 8, also referred to as an MIB definition, stored in the NMS and accessible to the management server 2, and in particular to its management module 3. An MIB definition 8 complies for example with the standard RFC 1213, in the case of the SNMP protocol, and generally describes, for the equipment 5 concerned, all its possible attributes, a data type (string, integer etc), the naming organisation, the text describing the equipment (or object), the access rights, the hierarchy of the objects (or equipment) and the like.

In addition, a memory 9 is provided coupled at least to the control device 1 and in which there are stored management data modules dedicated to each item of equipment 5 in the network and preferentially arranged in the form of what a person skilled in the art refers to as descriptors. A descriptor is a data processing module which contains all the data necessary for the management by the NMS of at least one equipment element (such as for example an integrated circuit card or a connection interface).

Each dedicated descriptor preferentially consists of at least one first program code file, preferably in Java language, which makes it possible to use an equipment interface 5, a second file containing data which designate a type of equipment, and a third file containing data which designate the MIB definition 8 associated with the equipment of the type in question, and at least one configuration file, for example of the XML type, which contains information for managing a type of equipment 5 in the network.

The program code files are preferentially in Java language, because of the ability of this language to load and unload computer codes dynamically. However, other languages can be envisaged, such as for example Small Talk, since they allow the dynamic loading and unloading of computer codes.

In the case of Java language, the code files are also called “classes”. Each descriptor is therefore associated with a principal class which possibly possesses certain dependencies with other classes. For example a descriptor A can be designed so as to function with a particular version CA of the principal class C, whilst a descriptor B can be designed so as to function with a particular version CB of this principal class C.

In the example illustrated, the memory 9 is located in the management server 2. However, it could be located in the control device 1 of the invention or in the management module 3 of the server 2 or in a dedicated external box coupled at least to the control device 1.

The control device 1 comprises a control module 10 arranged so as to extract from the memory 9 each descriptor dedicated to an item of equipment 5 which the management server 2 of the NMS wishes to take over, then to load this extracted dedicated descriptor into the management module 3 of the server 2. More precisely, according to the invention, the control module 10 is capable of loading the descriptors dynamically into the management module 3 so that it can continue to manage the other equipment in the network without being interrupted (and disturbed) by the loading operation.

When a descriptor is loaded into the management module 3 and the equipment 5 to which it is dedicated has synchronised itself to it, via the network, the management server 2 in which it is located is then capable of communicating with the said equipment 5. Because of the architecture used, of the “client/server” type, the management server 2 generally uses several strategies for keeping synchronised the information associated with the various items of equipment 5 which it manages. It may for example store the MIBs 6 of the equipment 5 in a cache memory and/or on a hard disk, or transmit all the requests to the items of equipment 5, or regularly interrogate (“polling”) the items of equipment 5, or listen to all the notifications which reach it from the network.

The data (or codes) comprised by the descriptors and which are loaded into (or “plugged into”) the management module 3 allow not only the management of the equipment but also the display of at least some of the information relating to the equipment 5 on a monitor coupled to the management server 2, by virtue of the graphical interface 4 of the GUI type.

Conventionally, the management of an item of equipment 5 at the control module 3 takes place by means of two types of command. A first type concerns the creation commands which configure each item of equipment 5 with the data which are specific to it, such as for example its type, version, address and the like. These data are stored in a memory dedicated to this purpose. When the management system is initiated (or started up), this memory is accessed to allow the loading of the appropriate MIB descriptors and definitions. A second type concerns the supervision commands which enable the management module 3 to synchronise its data with those of the equipment 5.

Several tens of descriptors, typically up to approximately fifteen, can thus be loaded into the management module 3 and into the graphical interface 4, via the management module 3.

The device 1 according to the invention is also preferentially arranged so as to manage the coexistence within the management module 3 of an old and new descriptor both associated with the same type of equipment 5. This is because, before integrating a new item of equipment or a new version of equipment in a network, the new description which is dedicated to it is loaded into the management module 3. This new descriptor, dedicated for example to the new version of an item of equipment, therefore coexists in the management module 3 with the old descriptor dedicated to the (so-called old) version of this equipment, which is still integrated in the network, unlike the new one.

In order to prevent this coexistence interfering with the management performed by the management module 3, in particular because of alarms signalling the absence of the new version, the control module 10 is arranged so as to put in a standby state each new descriptor which it has just loaded until the new version of the associated equipment is integrated. In this way the management module 3 can continue to manage the old version of the equipment using the loaded associated old descriptor as long as it remains integrated in the network. Next, when the control module 10 is advised by the management module 3 that the new version of the equipment has indeed been integrated in the network, it puts the new module in the “active” state and the old descriptor in the “inactive” state. The new descriptor is then in service and the management module 3 can provide the management of the new version of the equipment from this.

The integration is considered to be definitive when the management module 3 is assured that the data (and information) relating to the new equipment 5 are effectively synchronised with the descriptors dedicated to the various items of equipment in the network. It may in fact happen that a new equipment version (or a new item of equipment) is not compatible with the network management system. In this situation, the invention therefore makes it possible to ensure that an item of equipment is effectively integrated in the network before providing its management conjointly with that of the other equipment in the network.

In this embodiment of the control device 1, it is also preferable for the putting, by the control module 10, of a new descriptor in the standby state to consist firstly of making the management module 3 believe that the new version of the equipment 5 has indeed been integrated and that it must manage it using the new loaded descriptor without taking account of any error messages related to its actual non-integration within the network and secondly to send to the old descriptor a message indicating to it that a change of version is under way and that it must not take account of at least some of the error messages related to the coexistence of the old and new versions. Thus, as long as the data of a new item of equipment have not actually been synchronised, the management module 3 provides its supervision, via the associated new descriptor, according to a so-called “slave” mode, in contradistinction so a so-called “master” mode designating the supervision of the old version still synchronised via the old descriptor.

Such an operating mode appreciably reduces the time necessary for integrating each new item of equipment within a network.

Moreover, when an old descriptor has been placed in the inactive state and therefore the new version of the equipment has been considered to be effectively integrated in the network (its data being synchronised), it is preferable for the control module 10 to unload it from the management module 3. This unloading can be considered to be a deletion.

As indicated before, Java language is particularly advantageous in the context of the implementation of the invention and in particular the management of the coexistence of old and new management data modules (or descriptors). This is because this language offers a functionality called class loading (or “classloader”) which, according to its setting makes it possible to isolate or not isolate classes associated with different descriptors depending on whether or not it is wished to take account of any respective dependencies thereof. By virtue of this functionality, it is therefore possible to load a principal class C only once for all the descriptors (so as to take account of the dependencies of its subclasses) or to load subclasses CA and CB, for example, so as to not take account of any dependencies thereof (which is advantageously when some dependencies are incompatible).

The control module 10 is therefore arranged so as to function according to these two loading modes, depending on the choice of the supervisor.

It is important to note that this loading mode is not exclusive to Java language. Other languages use it, such as for example C#.

The management module 3, the management device 1 (and in particular its control module 10), as well as possibly the memory 3, can be implemented in the form of electronic circuits (or hardware), software or computer modules (or software), or a combination of circuits and software.

The invention also offers a method of controlling equipment management data 5 in a communications network, in which the network equipment 5 is managed from loaded management data modules associated with this network equipment.

This can be implemented by means of the control device 1 presented above. The principal functions and the optional sub-functions provided by the steps of this method being substantially identical to those provided by the various means constituting the control device 1, only the steps implementing the principal functions of the method according to the invention will be summarised below.

This method is characterised by the fact that it consists, in the case of a request to take over at least one new item of equipment 5 in the network, of dynamically loading each new management data module (or descriptor) associated with a new item of equipment 5, so that the management of the other equipment of the network is not interrupted.

Preferentially, in the case of the loading of a new management data module associated with a new version of an item of equipment 5 which has not yet been integrated in the network whilst an “old” management data module, associated with a prior version of this equipment, is still loaded and this prior version is still integrated in the network, it is advantageous to commence by putting the new management data module which has just been loaded on standby so as to continue the management of the old version of the equipment from the associated old module which has been loaded, until the new version of the equipment is integrated, and then to put the new loaded module in service when data are received indicating the integration of the new version, so that the management of the new version of the equipment is provided from this new management data module.

The invention is not limited to the embodiments of the method, control device 1 and management server 2 described above, solely by way of example, but encompasses all variants which can be envisaged by a person skilled in the art in the context of the following claims.

Thus a network is described in which the NMS management system comprised only one management server equipped with the control device according to the invention arranged so as to manage all the equipment in the network. However, the NMS management system could comprise several management servers each equipped with a control device according to the invention and arranged so as to allow the management of equipment parts in the network.

1. A device (1) for controlling equipment management data (5) in a communications network comprising a network management system capable of managing the said equipment using previously loaded management data modules, associated with the said equipment and stored in a memory (9), characterised in that it comprises control means (10) arranged, when there is a request by the said system to take over at least one new item of equipment (5) in the said network, to extract from the said memory (9) the management data module associated with each new item of equipment, and then to load into the said system each new management data module extracted, dynamically, so that the management by the said system of the other items of equipment (5) in the said network is not interrupted.

2. A device according to claim 1, characterised in that the said control means (10) are arranged, whenever a new management data module is loaded, associated with a new version of an item of equipment (5) which has not yet been integrated in the network whilst an “old” management data module associated with a prior version of this equipment (5) is still loaded and the said prior version is still integrated in the said network, i) to put the said new management data module loaded on standby so as to continue the management of the said old version of the equipment from the said old associated loaded module, until the said new version of the equipment (5) is integrated, and then ii), when data indicating the integration of the said new version are received, to put the said new module loaded into service so as to provide the management of the new version of the equipment (5) from this new management data module.

3. A device according to claim 2, characterised in that the said putting on standby consists firstly of allowing the management of the new version of the equipment (5) from the said new management data module, without taking account of any error messages related to its non-integration in the said network, and secondly to send to the said old management data module a message indicating to it that a change of version is under way and that it must not take account of at least some of the error messages related to the conjoint management of the old and new versions.

4. A device according to claim 2, characterised in that the said control means (10) are arranged, in the case of synchronisation between the said new equipment version (5) and the said new management data module, so as to delete the said old management data module.

5. A device according to claim 1, characterised in that the said control means (10) are arranged to load management data modules according to at least a first mode in which the said modules are loaded independently of any dependencies between them and a second mode in which, in loading the said modules, account is taken of any dependencies between them.

6. A device according to claim 1, characterised in that each management data module consists of at least one descriptor.

7. A device according to claim 6, characterised in that each descriptor consists of at least one program code file and at least one configuration file.

8. A device according to claim 7, characterised in that one of the said program code files of a descriptor comprises first data designating a type to which an item of network equipment belongs, and another of the said program code files of the said descriptor comprises second data designating a management information base definition associated with the said equipment (5) and accessible to the said system.

9. A device according to claim 7, characterised in that the said program codes are in Java language.

10. A management server (2) in a communications network, comprising management means (3) able to manage network equipment (5) using loaded management data modules, associated with the said network equipment (5) and stored in a memory (9), characterised in that it comprises a management device (1) according to claim 9, coupled to the said management means.

11. A method of controlling equipment management data (5) in a communications network, in which the said network equipment is managed using loaded management data modules, associated with the said network equipment (5), characterised in that, in the case of a request to take over at least one new item of equipment (5) in the said network, each new management data module associated with a new item of equipment (5) is loaded dynamically so that the management of the other equipment (5) in the said network is not interrupted.

12. A method according to claim 11, characterised in that, in the case of the loading of a new management data module associated with a new version of an item of equipment (5) not yet integrated in the said network whilst an “old” management data module associated with a prior version of this equipment (5) is still loaded and the said prior version is still integrated in the said network, i) the said new management data module loaded is put on standby so as to continue the management of the said old version of the equipment (5) using the said associated old module loaded, until the said new version of the equipment (5) is integrated, and then ii), on receiving data signalling the integration of the said new version, the said new management data module loaded is brought into service so as to provide the management of the new version of equipment (5) using this new management data module.

13. A method according to claim 12, characterised in that the said putting on standby consists firstly of allowing the management of the new version of the equipment (5) using the said associated new management data module without taking account of any error messages related to its non-integration in the said network, and secondly of sending to the said old management data module a message signalling to it that a change of version is under way and that it must not take account of at least some of the error messages related to the conjoint management of the said old and new versions.

14. A method according to claim 12, characterised in that, in the case of synchronisation between the said new equipment version (5) and the said new management data module, the said old management data module is deleted.

15. A method according to claim 11, characterised in that the management data modules are loaded independently of any dependencies thereof or taking account of any dependencies thereof.

16. A method according to claim 12, characterised in that each management data module consists of at least one descriptor.

17. A method according to claim 16, characterised in that each descriptor consists of at least one program code file and at least one configuration file.

18. A method according to claim 17, characterised in that one of the said program code files of the descriptor comprises first data designating a type to which an item of equipment in the network belongs, and another of the said program code files of the said descriptor comprises second data designating a management information base definition associated with the said equipment (5) and accessible.

19. A method according to claim 18, characterised in that the said program codes are in Java language.

20. Use of the method, control device (1) and management server (2) according to claim 19 in the network technologies which are to be managed.

21. Use according to claim 20, characterised in that the said network technologies are chosen from a group comprising the transmission networks, in particular of the WDM, SONET and SDH type, data networks, in particular of the Internet-IP and ATM type, and voice networks, in particular of the conventional, mobile and NGN type.
